(19) United States
(12) Patent Application Publication
(10) Pub. No.: US 2022/0219712 A1
(43) Pub. Date: Jul. 14, 2022

(54) APPARATUS, SYSTEM, AND METHOD OF HEATING A WINDOW FOR A SENSOR DEVICE

(71) Applicant: Intel Corporation, Santa Clara, CA (US)

(72) Inventors: Ron Friedman, Kibutz Givat Oz (IL); Israel Petronius, Haifa (IL)

(73) Assignee: Intel Corporation, Santa Clara, CA (US)

(21) Appl. No.: 17/710,793

(22) Filed: Mar. 31, 2022

(51) Int. Cl. B60W 50/00; H05B 3/84; G01S 17/88

(52) U.S. Cl. CPC B60W 50/0098; B60W 2420/52; G01S 17/88; H05B 3/84

(57) ABSTRACT

For example, an apparatus may include a housing including a window; a sensor within the housing, the light-based sensor to generate sensor information based on light of a first configuration received via the window; and a light projector within the housing, the light projector configured to project light of a second configuration onto the window, wherein the light of the second configuration is configured such that the window is to be heated by absorption of the light of the second configuration.

### TECHNICAL FIELD

Aspects described herein generally relate to heating a window for a sensor device.

### BACKGROUND

Some systems may utilize a light-based sensor device, which includes a light based sensor, e.g., a photo detector, cameras and/or the like.

In some systems, the light-based sensor may be implemented within a housing, e.g., to protect the light-based sensor from environment conditions.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a light-based sensor, in accordance with some demonstrative aspects.

FIG. 2 is a schematic block diagram illustration of a robot implementing a light-based sensor, in accordance with some demonstrative aspects.

FIG. 3 is a schematic block diagram illustration of a light-based sensor apparatus, in accordance with some demonstrative aspects.

FIG. 4 is a schematic illustration of a light-based sensor device, in accordance with some demonstrative aspects.

FIG. 5 is a schematic illustration of an isometric view of a light-based sensor device, in accordance with some demonstrative aspects.

FIG. 6 is a schematic illustration of a heating scheme to heat a window for a light-based sensor device, in accordance with some demonstrative aspects.

FIG. 7 is a schematic illustration of a graph depicting a transmission spectrum of a glass substrate versus wavelength, in accordance with some demonstrative aspects.

FIG. 8 is a schematic illustration of a graph depicting absorption of an Anti-Reflective Coating (ARC) layer versus wavelength, in accordance with some demonstrative aspects.

FIG. 9 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects”, “one embodiment”, “an embodiment”, “demonstrative embodiment”, “various embodiments” etc., indicate that the aspect(s) and/or embodiments so described may include a particular feature, structure, or characteristic, but not every aspect or aspect necessarily includes the particular feature, structure, or characteristic. Further, repeated use of the phrase “in one aspect” or “in one embodiment” does not necessarily refer to the same aspect or embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a light-based sensor, a light-based sensor device, a light-based sensor system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with light-based sensor systems, vehicular light-based sensor systems, Light Detection And Ranging (LiDAR) systems, vehicular sensor systems, autonomous systems, robotic systems, detection systems, or the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a communication signal includes transmitting and/or emitting the communication signal, and/or receiving and/or detecting the communication signal. For example, a communication unit, which is capable of communicating a communication signal, may include a transmitter and/or emitter to transmit and/or emit the communication signal, and/or a communication receiver and/or detector to receive and/or detect a communication signal. The verb communicating may be used to refer to the action of transmitting/emitting or the action of receiving/detecting. In one example, the phrase “communicating a transmission signal” may refer to the action of transmitting/emitting the signal by a first device, and may not necessarily include the action of receiving/detecting the signal by a second device. In another example, the phrase “communicating a transmission signal” may refer to the action of receiving/detecting the signal by a first device, and may not necessarily include the action of transmitting/emitting the signal by a second device. The communication signal may be transmitted and/or received, for example, in the form of wireless communication signals, and/or any other type of signal.

For example, the term “communicating” as used herein with respect to alight signal includes transmitting and/or emitting the light signal, and/or receiving and/or detecting the light signal. For example, a communication unit, which is capable of communicating a light signal, may include an emitter to emit the light signal, and/or a detector to detect and/or receive the light signal. The verb communicating may be used to refer to the action of transmitting/emitting or the action of receiving/detecting. In one example, the phrase “communicating a light signal” may refer to the action of transmitting/emitting the signal by a first device, and may not necessarily include the action of receiving/detecting the light signal by a second device. In another example, the phrase “communicating a light signal” may refer to the action of receiving/detecting the light signal by a first device, and may not necessarily include the action of transmitting/emitting the light signal by a second device.

Some demonstrative aspects are described herein with respect to light-based systems, for example, utilizing light-based sensors, e.g., Light Detection And Ranging (LiDAR) systems, utilizing light signals. However, other aspects may be implemented with respect to, or in conjunction with, any other signals, e.g., radar signals, sonar systems, wireless signals, IR signals, acoustic signals, optical signals, wireless communication signals, communication scheme, network, standard, and/or protocol.

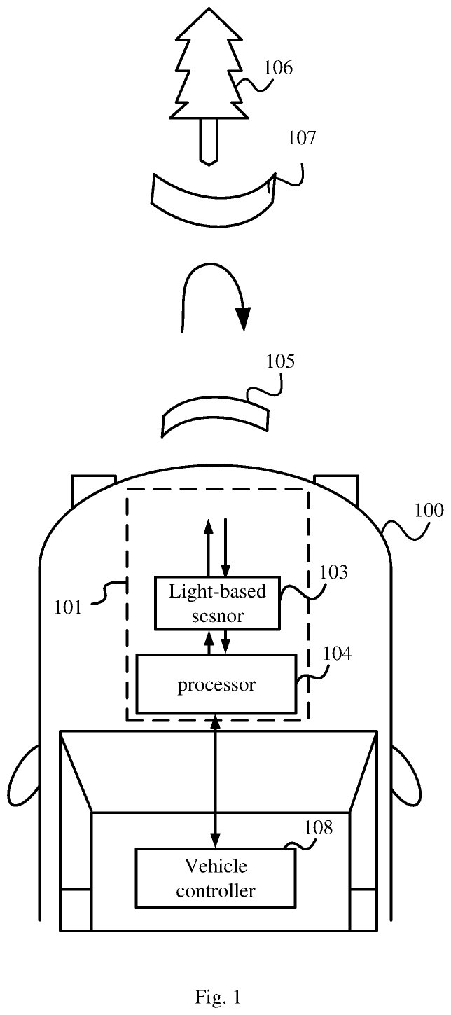

Reference is now made to FIG. 1, which schematically illustrates a block diagram of a vehicle 100 implementing a light-based sensor, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a light-based sensor device 101, e.g., as described below. For example, light-based sensor device 101 may include a light-based sensor detecting device, a light-based sensing device, a light-based sensor, or the like, e.g., as described below.

In some demonstrative aspects, light-based sensor device 101 may be implemented as part of a vehicular system, for example, a system to be implemented and/or mounted in vehicle 100.

In one example, light-based sensor device 101 may be implemented as part of an autonomous vehicle system, an automated driving system, an assisted vehicle system, a driver assistance and/or support system, and/or the like.

For example, light-based sensor device 101 may be installed in vehicle 100 for detection of nearby objects, e.g., for autonomous driving.

In some demonstrative aspects, light-based sensor device 101 may be configured to detect targets in a vicinity of vehicle 100, e.g., in a far vicinity and/or a near vicinity, for example, using light waves and/or signals, e.g., as described below.

In one example, light-based sensor device 101 may be mounted onto, placed, e.g., directly, onto, or attached to, vehicle 100.

In some demonstrative aspects, vehicle 100 may include a plurality of light-based sensor devices 101. In other aspects, vehicle 100 may include a single light-based sensor device 101.

In some demonstrative aspects, vehicle 100 may include a plurality of light-based sensor devices 101, which may be configured to cover a field of view of 360 degrees around vehicle 100.

In other aspects, vehicle 100 may include any other suitable count, arrangement, and/or configuration of light-based sensor devices and/or units, which may be suitable to cover any other field of view, e.g., a field of view of less than 360 degrees.

In some demonstrative aspects, light-based sensor device 101 may be implemented as a component in a suite of sensors used for driver assistance and/or autonomous vehicles.

In some demonstrative aspects, light-based sensor device 101 may be configured to support autonomous vehicle usage, e.g., as described below.

In one example, light-based sensor device 101 may determine a class, a location, an orientation, a velocity, an intention, a perceptional understanding of the environment, and/or any other information corresponding to an object in the environment.

In another example, light-based sensor device 101 may be configured to determine one or more parameters and/or information for one or more operations and/or tasks, e.g., path planning, and/or any other tasks.

In some demonstrative aspects, light-based sensor device 101 may be configured to map a scene by measuring targets' reflectivity and discriminating them, for example, mainly in range, velocity, azimuth and/or elevation, e.g., as described below.

In some demonstrative aspects, light-based sensor device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, light-based sensor device 101 may include a light-based sensor 103 configured to communicate light signals, and a processor 104 configured to generate light-based sensor information based on the light signals, e.g., as described below.

In some demonstrative aspects, processor 104 may be configured to process the light-based sensor information of light-based sensor device 101 and/or to control one or more operations of light-based sensor device 101, e.g., as described below.

In some demonstrative aspects, processor 104 may include, or may be implemented, partially or entirely, by circuitry and/or logic, e.g., one or more processors including circuitry and/or logic, memory circuitry and/or logic. Additionally or alternatively, one or more functionalities of processor 104 may be implemented by logic, which may be executed by a machine and/or one or more processors, e.g., as described below.

In one example, processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, processor 104 may be implemented by one or more additional or alternative elements of vehicle 100.

In some demonstrative aspects, light-based sensor 103 may include a LiDAR sensor, e.g., as described below.

In other aspects, light-based sensor 103 may include any other additional type of light-based sensor configured to generate light-based sensor information based on sensed and/or detected light.

In some demonstrative aspects, light-based sensor 103 may include, for example, one or more light transmitters, and/or a one or more light receivers/detectors, e.g., as described below.

In some demonstrative aspects, as shown in FIG. 1, the light-based sensor 103 may be controlled, e.g., processor 104, to transmit a light signal 105.

In some demonstrative aspects, as shown in FIG. 1, the light signal 105 may be reflected by an object 106, resulting in reflected light 107.

In some demonstrative aspects, the light-based sensor device 101 may receive the reflected light 107, e.g., via light-based sensor 103, and processor 104 may generate sensor information, for example, by calculating information about position, radial velocity, and/or direction of the object 106, e.g., with respect to vehicle 100.

In some demonstrative aspects, processor 104 may be configured to provide the sensor information to a vehicle controller 108 of the vehicle 100, e.g., for autonomous driving of the vehicle 100.

In some demonstrative aspects, at least part of the functionality of processor 104 may be implemented as part of vehicle controller 108. In other aspects, the functionality of processor 104 may be implemented as part of any other element of light-based sensor device 101 and/or vehicle 100. In other aspects, processor 104 may be implemented, as a separate part of, or as part of any other element of light-based sensor device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control light-based sensor device 101, and/or to process one or parameters, attributes and/or information from light-based sensor device 101.

In some demonstrative aspects, vehicle controller 108 may be configured, for example, to control the vehicular systems of the vehicle 100, for example, based on sensor information from light-based sensor device 101 and/or one or more other sensors of the vehicle 100, e.g., radar sensors, camera sensors, and/or the like.

In one example, vehicle controller 108 may control the steering system, the braking system, and/or any other vehicular systems of vehicle 100, for example, based on the information from light-based sensor device 101, e.g., based on one or more objects detected by light-based sensor device 101.

In other aspects, vehicle controller 108 may be configured to control any other additional or alternative functionalities of vehicle 100.

Some demonstrative aspects are described herein with respect to a light-based sensor device 101 implemented in a vehicle, e.g., vehicle 100. In other aspects a light-based sensor device, e.g., light-based sensor device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, light-based sensor device 101 may be part of a non-vehicular device, which may be implemented, for example, in an indoor location, a stationary infrastructure outdoors, or any other location.

In some demonstrative aspects, light-based sensor device 101 may be configured to support security usage. In one example, light-based sensor device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, light-based sensor device 101 may be configured to support any other usages and/or applications.

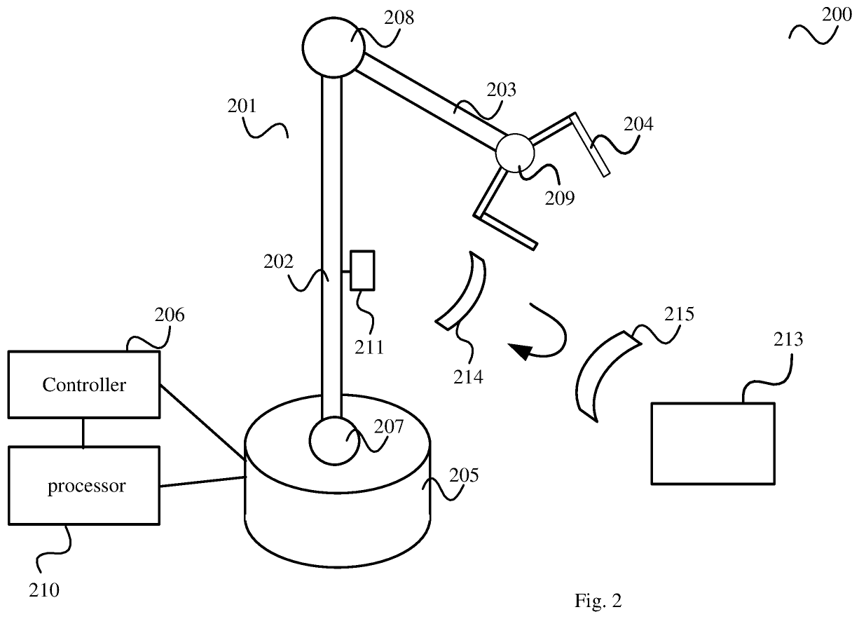

Reference is now made to FIG. 2, which schematically illustrates a block diagram of a robot 200 implementing a light-based sensor, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a processor 210 of the robot 200.

In some demonstrative aspects, a light-based sensor 211 may be coupled to the processor 210. In one example, light-based sensor 211 may be included, for example, as part of the robot arm 201.

In some demonstrative aspects, the light-based sensor 211, and the processor 210 may be operable as, and/or may be configured to form, a light-based sensor device. For example, light-based sensor 211 may be configured to perform one or more functionalities of light-based sensor 103 (FIG. 1), and/or processor 210 may be configured to perform one or more functionalities of processor 104 (FIG. 1), e.g., as described above.

In some demonstrative aspects, light-based sensor 211 may include a LiDAR sensor, e.g., as described below.

In other aspects, light-based sensor 211 may include any other additional type of light-based sensor configured to generate light-based sensor information based on sensed and/or detected light.

In some demonstrative aspects, for example, the light-based sensor 211 may be controlled, e.g., by processor 210, to transmit a light signal 214.

In some demonstrative aspects, as shown in FIG. 2, the light signal 214 may be reflected by the object 213, resulting in reflected light 215.

In some demonstrative aspects, the reflected light 215 may be received, e.g., via light-based sensor 211, and processor 210 may generate sensor information, for example, by calculating information about position, speed and/or direction of the object 213, e.g., with respect to robot arm 201.

In some demonstrative aspects, processor 210 may be configured to provide the sensor information to the robot controller 206 of the robot arm 201, e.g., to control robot arm 201. For example, robot controller 206 may be configured to control robot arm 201 based on the sensor information, e.g., to grab the object 213 and/or to perform any other operation.

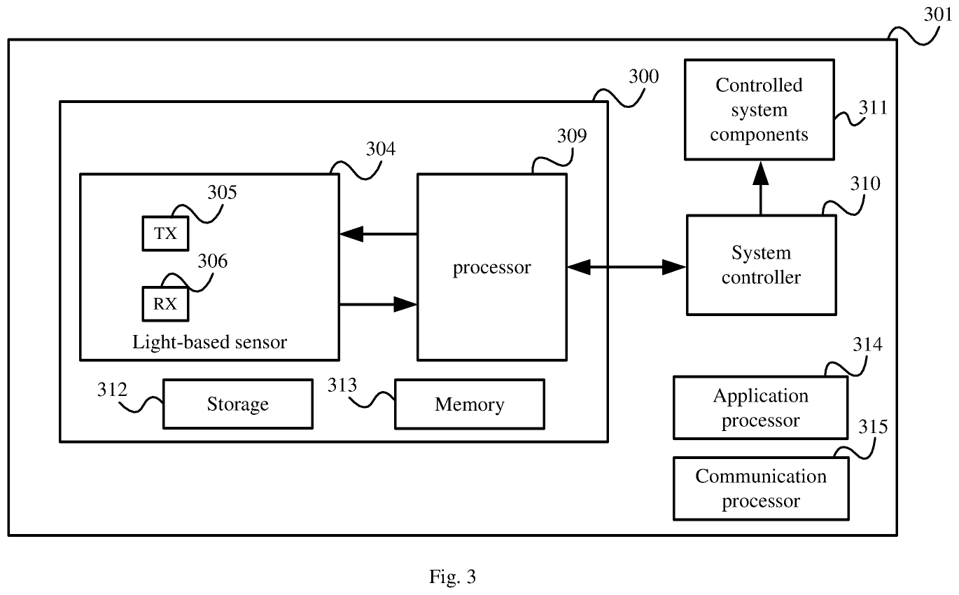

Reference is made to FIG. 3, which schematically illustrates a light-based sensor apparatus 300, in accordance with some demonstrative aspects.

In some demonstrative aspects, light-based sensor apparatus 300 may be implemented as part of a device or system 301, e.g., as described below.

For example, light-based sensor apparatus 300 may be implemented as part of, and/or may configured to perform one or more operations and/or functionalities of, the devices or systems described above with reference to FIG. 1 an/or FIG. 2. In other aspects, light-based sensor apparatus 300 may be implemented as part of any other device or system 301.

In some demonstrative aspects, light-based sensor device 300 may include a light-based sensor 304, and a processor 309.

In some demonstrative aspects, light-based sensor 304 may include a LiDAR sensor, e.g., as described below.

In other aspects, light-based sensor 304 may include any other additional type of light-based sensor configured to generate light-based sensor information based on sensed and/or detected light.

In some demonstrative aspects, as shown in FIG. 3, light-based sensor 304 may include a light transmitter 305 and a light receiver 306, e.g., as described below.

In some demonstrative aspects, light transmitter 305 may include one or more elements, for example, a light source, optic elements, and/or one or more other elements, configured to generate light signals to be emitted by the light-based sensor 304.

In some demonstrative aspects, for example, processor 309 may provide digital transmit data values to the light-based sensor 304.

In some demonstrative aspects, receiver 306 may include one or more elements, for example, one or more photo detectors, one or optical elements and/or one or more other elements, configured to detect and/or process, light signals received by light receiver 306.

In some demonstrative aspects, for example, light receiver 306 may be configured to convert a detected light signal into digital reception data values based on the detected light. For example, light-based sensor 304 may provide the digital reception data values to the processor 309.

In some demonstrative aspects, processor 309 may be configured to process the digital reception data values, for example, to detect one or more objects, e.g., in an environment of the device/system 301. This detection may include, for example, the determination of information including one or more of range, speed, direction, and/or any other information, of one or more objects, e.g., with respect to the system 301.

In some demonstrative aspects, processor 309 may be configured to provide the determined sensor information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, light-based sensor device 300 may include a storage 312 or a memory 313, e.g., to store information processed by apparatus 300, for example, digital reception data values being processed by the processor 309, sensor information generated by processor 309, and/or any other data to be processed by processor 309.

In some demonstrative aspects, device/system 301 may include, for example, an application processor 314 and/or a communication processor 315, for example, to at least partially implement one or more functionalities of system controller 310 and/or to perform communication between system controller 310, light-based sensor device 300, the controlled system components 311, and/or one or more additional elements of device/system 301.

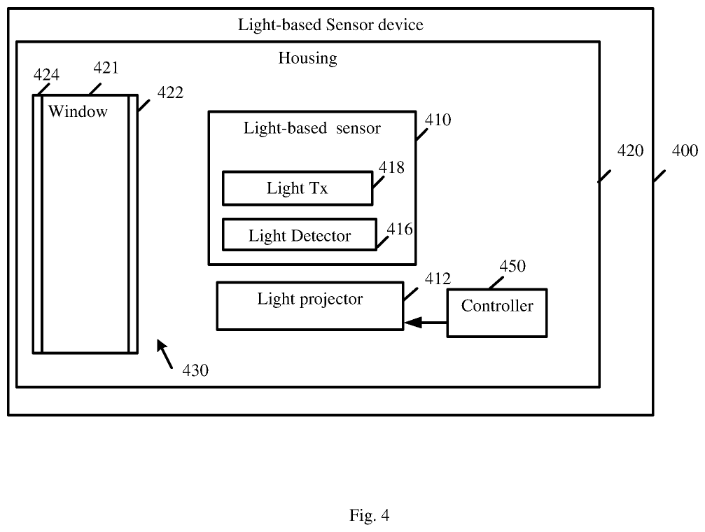

Reference is made to FIG. 4, which schematically illustrates a light-based sensor device 400, in accordance with some demonstrative aspects. For example, light-based sensor device 101 (FIG. 1), robot 200 (FIG. 2), and/or light-based sensor device 300 (FIG. 3), may include one or more elements of light-based sensor device 400, and/or may perform one or more operations and/or functionalities of light-based sensor device 400.

In some demonstrative aspects, as shown in FIG. 4, device 400 may include a light-based sensor 410. For example, light-based sensor 103 (FIG. 1), light-based sensor 211 (FIG. 2), and/or light-based sensor 304 (FIG. 3) may include one or more elements of light-based sensor 410, and/or may perform one or more operations and/or functionalities of light-based sensor device 410.

In some demonstrative aspects, device 400 may include a housing 420 configured to house the light-based sensor 410, e.g., as described below.

In some demonstrative aspects, housing 420 may include a window 430, for example, to enable light to be received by light-based sensor 410, e.g., via the window 430.

In some demonstrative aspects, light-based sensor 410 may be configured to generate sensor information, for example, based on light received via the window 430, e.g., as described below.

In some demonstrative aspects, light-based sensor 410 may include a LiDAR sensor.

In other aspects, light-based sensor 410 may include any other additional or alternative type light-based sensor configured to generate sensor information, for example, based on light received via the window 430.

In some demonstrative aspects, light-based sensor 410 may include a light transmitter 418 configured to transmit light via the window 430, e.g., as described below. For example, light transmitter 418 may include one or more elements of light transmitter 305 (FIG. 3), and/or may perform one or more operations and/or functionalities of light transmitter 305 (FIG. 3).

In some demonstrative aspects, light-based sensor 410 may include a light detector 416 to detect light received via the window 430 e.g., as described below. For example, light detector 416 may include one or more elements of light receiver 306 (FIG. 3), and/or may perform one or more operations and/or functionalities of light receiver 306 (FIG. 3).

In some demonstrative aspects, device 400 may be configured, for example, to provide a technical solution to protect a surface of the window 430 from environment conditions, which may block light transfer, e.g., via window 430, between light-based sensor 410 and an environment of device 400, e.g., as described below.

In some demonstrative aspects, device 400 may be configured, for example, to provide a technical solution to mitigate and/or prevent accumulation of one or more substances on a surface of window 430, for example, to support proper and/or safe performance of light-based sensor 410, e.g., as described below.

For example, ice, snow and/or condensation may build up on the window 430, for example, when an ambient temperature is below 0° Celsius (° C.).

In some demonstrative aspects, device 400 may be configured to provide a technical solution to support prevention of, and/or removal of, the ice, snow and/or condensation over the window 430, e.g., as described below.

In some demonstrative aspects, device 400 may be configured, for example, to provide a technical solution to remove, defrost, and/or de-ice one or more substances, for example, precipitation substances, e.g., snow, ice, rain, hail, or the like, from the window 430, for example, to avoid performance degradation of light based sensor 410, for example, in various weather conditions, e.g., rain, snow, hail, icing, humidity, fog, or the like.

In some demonstrative aspects, device 400 may be configured, for example, to remove, defrost, and/or de-ice one or more substances on the window 430, for example, by heating one or more parts of the window 430, e.g., as described below.

In some demonstrative aspects, device 400 may be configured, for example, to remove, defrost, and/or de-ice one or more substances on the window 430, for example, prior to starting operation of light-based sensor 410, e.g., at a cold-start when ice/condensation has accumulated on the window 430 and should be removed.

In some demonstrative aspects, device 400 may be configured, for example, to remove, defrost, and/or de-ice one or more substances on the window 430, for example, during operation of light-based sensor 410, for example, to prevent accumulation of ice/condensation on the window 430.

In some demonstrative aspects, for example, in some use cases, scenarios, and/or implementations, techniques implementing an electrical heater to heat a window may suffer from one or more technical issues. In one example, some techniques may implement an electrical heater, which is bonded to an inside part of a window and outside an optical clear aperture. These techniques implementing the electrical heater may not be sufficient for heating a window in some use cases and/or implementations. For example, in case a window is formed from relatively think glass having a relatively low thermal conductivity, it may be expected that a central region of the window may not reach a required temperature to remove the ice and/or condensation. For example, in case the window is formed from relatively think glass having a relatively low thermal conductivity, it may be expected that a process duration to evaporate and/or heat the ice and/or the condensation may be very long, e.g., beyond operational requirements.

In some demonstrative aspects, for example, in some use cases, scenarios, and/or implementations, techniques implementing a thin Iridium Tin Oxide (ITO) layer on an inner surface of a clear aperture may suffer from one or more technical issues if implemented by a device using a light-based sensor. In one example, the thin ITO layer may degrade performance of the light-based sensor, for example, if a transmission spectrum the ITO layer covers Near Infrared (NIR) and/or Middle Wavelength Infrared (MWIR) wavelengths, which may be used by the light-based sensor. For example, the ITO layer may degrade transmit and/or receive optical signals of the light-based sensor, and/or may increase a back reflection risk.

In some demonstrative aspects, device 400 may be configured to implemented a projected-light mechanism, for example, to provide a technical solution to mitigate and/or prevent accumulation of one or more substances on a surface of window 430, e.g., as described below.

In some demonstrative aspects, device 400 may be configured to implemented a projected-light mechanism, which may utilize a light projector 412 to generate projected light, e.g., a high power light, which may be projected onto a back side of window 430, for example, in order to heat window 430, e.g., as described below.

In some demonstrative aspects, the projected light may be configured such that it may be, at least partially, absorbed by one or more layers of window 430, e.g., a glass substrate material of window 430, an Anti-Reflection Coating (ARC) on inner and/or outer surfaces of window 430, a light-absorption layer, and/or any other additional or alternative layer of window 430, e.g., as described below.

In some demonstrative aspects, light projector 412 may be configured to generate the projected light having a wavelength, e.g., spectrum, and/or a polarization, which may be configured to be absorbed, at least partially, by window 430, e.g., as described below.

In some demonstrative aspects, one or more components of light-based sensor device 400 may be configured, for example, to provide a technical solution to heat window 430, e.g., uniformly, across substantially an entirety of the window 430, e.g., as described below.

In some demonstrative aspects, one or more components of light-based sensor device 400 may be configured, for example, to provide a technical solution to heat window 430, for example, without substantially interfering with operation of the light-based sensor 410, e.g., as described below.

In some demonstrative aspects, a coherent nature of the light-based system 410, e.g., a LiDAR system, may be utilized to provide a technical solution to allow high power radiation, e.g., from the light projector 412, to heat window 430, for example, while avoiding interference to the LiDAR operation, e.g., avoiding intermixing and/or a back-reflection risk.

In some demonstrative aspects, components of light-based sensor device 400 may be configured, for example, to support a technical solution, in which one or more optical layers of window 430 may be optimized for maximal efficiency, e.g., in terms of composition and/or thicknesses, for example, while avoiding impact on functional performance of light-based sensor 410, and/or while achieving efficient evaporation/de-freezing of window 430, for example, in one or more selected spectra of the projected light, e.g., as described below.

In some demonstrative aspects, light-based sensor 410 may be configured to generate sensor information, for example, based on light of a first configuration received via the window 430, e.g., as described below.

In some demonstrative aspects, light transmitter 418 may be configured to transmit the light of the first configuration via the window 430, e.g., as described below.

In some demonstrative aspects, light detector 416 may be configured to detect the light of the first configuration received via the window 430, e.g., as described below.

In some demonstrative aspects, the light of the first configuration, as transmitted by light transmitter 418, may include light having a wavelength, which is in a wavelength range between about 800 nm and about 1500 nm, e.g., as described below.

In some demonstrative aspects, the light of the first configuration, as transmitted by light transmitter 418, may include light having a wavelength, which is in a wavelength range between about 1000 nm and about 1300 nm, e.g., as described below.

In other aspects, the light of the first configuration, as transmitted by light transmitter 418, may include light of any other wavelength.

In some demonstrative aspects, window 430 may be configured to transmit at least 80% of the light of the first configuration, as transmitted by light transmitter 418, e.g., as described below.

In some demonstrative aspects, window 430 may be configured to transmit at least 90% of the light of the first configuration, as transmitted by light transmitter 418, e.g., as described below.

In other aspects, window 430 may be configured to transmit any other portion of the light of the first configuration, as transmitted by light transmitter 418.

In some demonstrative aspects, light-based sensor device 400 may include at least one light projector 412 configured to project light of a second configuration onto the window 430, e.g., as described below.

In some demonstrative aspects, the light projector 412 may include a Light Emitting Diode (LED), for example, to generate the light of the second configuration.

In some demonstrative aspects, the light projector 412 may include a diffused laser, for example, to generate the light of the second configuration.

In some demonstrative aspects, the light projector 412 may include a Vertical Cavity Surface Emitting Lasers (VCSEL) array, for example, to generate the light of the second configuration.

In other aspects, the light projector 412 may include any other additional or alternative light source to generate the projected light of the second configuration.

In some demonstrative aspects, the light projector 412 may be configured to generate the light of the second configuration, which is configured such that the window 430 is to be heated by absorption of the light of the second configuration, e.g., as described below.

In some demonstrative aspects, the light projector 412 may be configured to generate the light of the second configuration configured to heat the window 430, for example, by absorption of at least 30% of the light of the second configuration by the window 430, e.g., as described below.

In some demonstrative aspects, the light projector 412 may be configured to generate the light of the second configuration configured to heat the window 430, for example, by absorption of at least 40% of the light of the second configuration by the window 430, e.g., as described below.

In some demonstrative aspects, the light projector 412 may be configured to generate the light of the second configuration configured to heat the window 430, for example, by absorption of at least 50% of the light of the second configuration by the window 430, e.g., as described below.

In some demonstrative aspects, the light projector 412 may be configured to generate the light of the second configuration configured to heat the window 430, for example, by absorption of at least 60% of the light of the second configuration by the window 430, e.g., as described below.

In some demonstrative aspects, the light projector 412 may be configured to generate the light of the second configuration configured to heat the window 430, for example, by absorption of at least 70% of the light of the second configuration by the window 430, e.g., as described below.

In some demonstrative aspects, the light projector 412 may be configured to generate the light of the second configuration configured to heat the window 430, for example, by absorption of at least 80% of the light of the second configuration by the window 430, e.g., as described below.

In some demonstrative aspects, the light projector 412 may be configured to generate the light of the second configuration configured to heat the window 430, for example, by absorption of at least 90% of the light of the second configuration by the window 430, e.g., as described below.

In other aspects, the light projector 412 may be configured to generate the light of the second configuration configured to heat the window 430, for example, by absorption of any other portion of the light of the second configuration by the window 430.

In some demonstrative aspects, the light projector 412 may be configured to generate the light of the second configuration configured to heat the window 430, for example, at a rate of at least 1 degree Celsius per minute, e.g., as described below.

In some demonstrative aspects, the light projector 412 may be configured to generate the light of the second configuration configured to heat the window 430, for example, at a rate of at least 2 degree Celsius per minute, e.g., as described below.

In some demonstrative aspects, the light projector 412 may be configured to generate the light of the second configuration configured to heat the window 430, for example, at a rate of at least 5 degree Celsius per minute, e.g., as described below.

In some demonstrative aspects, the light projector 412 may be configured to generate the light of the second configuration configured to heat the window 430, for example, at a rate of at least 10 degree Celsius per minute, e.g., as described below.

In other aspects, the light projector 412 may be configured to generate the light of the second configuration configured to heat the window 430, for example, at any other rate.

In some demonstrative aspects, the light projector 412 may be configured to generate the light of the second configuration including light of a wavelength, which is at least 30% absorbed by the window 430, e.g., as described below.

In some demonstrative aspects, the light projector 412 may be configured to generate the light of the second configuration including light of a wavelength, which is at least 40% absorbed by the window 430.

In some demonstrative aspects, the light projector 412 may be configured to generate the light of the second configuration including light of a wavelength, which is at least 50% absorbed by the window 430.

In some demonstrative aspects, the light projector 412 may be configured to generate the light of the second configuration including light of a wavelength, which is at least 60% absorbed by the window 430.

In some demonstrative aspects, the light projector 412 may be configured to generate the light of the second configuration including light of a wavelength, which is at least 70% absorbed by the window 430.

In some demonstrative aspects, the light projector 412 may be configured to generate the light of the second configuration including light of a wavelength, which is at least 80% absorbed by the window 430.

In some demonstrative aspects, the light projector 412 may be configured to generate the light of the second configuration including light of a wavelength, which is at least 90% absorbed by the window 430.

In other aspects, the light projector 412 may be configured to generate the light of the second configuration including light of a wavelength having any other absorption percentage by window 430.

In some demonstrative aspects, the light projector 412 may be configured to generate the light of the second configuration including light of a polarity which is at least 30% absorbed by the window 430, e.g., as described below.

In some demonstrative aspects, the light projector 412 may be configured to generate the light of the second configuration including light of a polarity which is at least 40% absorbed by the window 430.

In some demonstrative aspects, the light projector 412 may be configured to generate the light of the second configuration including light of a polarity which is at least 50% absorbed by the window 430.

In some demonstrative aspects, the light projector 412 may be configured to generate the light of the second configuration including light of a polarity which is at least 60% absorbed by the window 430.

In some demonstrative aspects, the light projector 412 may be configured to generate the light of the second configuration including light of a polarity which is at least 70% absorbed by the window 430.

In some demonstrative aspects, the light projector 412 may be configured to generate the light of the second configuration including light of a polarity which is at least 80% absorbed by the window 430.

In some demonstrative aspects, the light projector 412 may be configured to generate the light of the second configuration including light of a polarity which is at least 90% absorbed by the window 430.

In other aspects, the light projector 412 may be configured to generate the light of the second configuration including light of a polarity having any other absorption percentage by window 430.

In some demonstrative aspects, window 430 may include a window layer 421, e.g., as described below.

In some demonstrative aspects, window 430 may include one or more inner layers 422 on window layer 421, for example, between window layer 421 and light projector 412, e.g., as described below.

In some demonstrative aspects, window 430 may include one or more outer layers 424 on window layer 421, for example, on an outer-facing surface of window layer 421, for example, such that window layer 421 is between light projector 412 and layers 424, e.g., as described below.

In some demonstrative aspects, window layer 421 of window 430 may include a glass substrate configured to absorb at least 30% of light of the second configuration, e.g., as described below.

In some demonstrative aspects, the light projector 412 may be configured to generate the light of the second configuration including light having a wavelength, which is in a wavelength range between about 600 nm and about 700 nm, e.g., as described below.

In some demonstrative aspects, the light projector 412 may be configured to generate the light of the second configuration including light having a wavelength, which is in a wavelength range between about 650 nm and about 680 nm, e.g., as described below.

In some demonstrative aspects, the light projector 412 may be configured to generate the light of the second configuration including UV light, e.g., as described below.

In some demonstrative aspects, the light projector 412 may be configured to generate the light of the second configuration including light having a wavelength, which is in a wavelength range between about 250 nm and about 300 nm, e.g., as described below.

In other aspects, the light projector 412 may be configured to generate the light of the second configuration including any other UV light.

In some demonstrative aspects, the light projector 412 may be configured to generate the light of the second configuration including Mid-wave Infra-Red (MWIR) light, e.g., as described below.

In some demonstrative aspects, the light projector 412 may be configured to generate the light of the second configuration including light having a wavelength, which is greater than about 2400 nm, e.g., as described below.

In other aspects, the light projector 412 may be configured to generate the light of the second configuration including any other MWIR light.

In some demonstrative aspects, the light of the second configuration may include light having a wavelength, which is in a wavelength range between about 400 nm and about 600 nm, e.g., as described below.

In some demonstrative aspects, the light of the second configuration may include light having a wavelength, which is in a wavelength range between about 420 nm and about 480 nm, e.g., as described below.

In some demonstrative aspects, window 430 may include a reflective layer on the window layer 421, for example, such that the window layer 421 is between the light projector 412 and the reflective layer. For example, window layers 424 may include the reflective layer, e.g., as described below.

In some demonstrative aspects, the reflective layer may be configured to reflect the light of the second configuration onto the window layer 421, e.g., as described below. For example, the light of the second configuration may be projected by the light projector 412 onto the window 430, while some portion of the light of the second configuration may pass through the window layer 421. For example, the reflective layer may be configured to reflect back onto the window layer 421 at least part of the light that passed through the window layer 421.

In some demonstrative aspects, window 430 may include an absorption layer, e.g., on the window layer 421. For example, one or more of the window layers 422 and/or 424 may include the absorption layer, e.g., as described below.

In some demonstrative aspects, the light projector 412 may be configured to generate the light of the second configuration including light configured to heat the window 430, for example, by absorption of at least 30% of the light by the window layer 421 and/or the absorption layer, e.g., as described below.

In some demonstrative aspects, window 430 may include an ARC layer on the window layer 421. For example, one or more of the layers 422 and/or 424 may include the ARC layer, e.g., as described below.

In some demonstrative aspects, the light projector 412 may be configured to generate the light of the second configuration including light configured to heat the window 430, for example, by absorption of at least 30% of the light by at least one of the window layer 421 and/or the ARC layer.

In some demonstrative aspects, the ARC layer may be configured to absorb at least 30% of light in the wavelength range between about 400 nm and about 600 nm, e.g., as described below.

In some demonstrative aspects, light-based sensor 410 may include a controller 450 configured to control activation of the light projector 412, e.g., as described below.

In some demonstrative aspects, controller 450 may include, or may be implemented, partially or entirely, by circuitry and/or logic, e.g., one or more processors including circuitry and/or logic, memory circuitry and/or logic, and/or any other circuitry and/or logic, configured to perform the functionality of controller 450. Additionally or alternatively, one or more functionalities of controller 450 may be implemented by logic, which may be executed by a machine and/or one or more processors, e.g., as described below.

In some demonstrative aspects, controller 450 may be configured to control activation of the light projector 412, for example, based on an environment temperature in an environment of the housing 420, e.g., as described below.

In some demonstrative aspects, controller 450 may be configured to control activation of the light projector 412, for example, based on an environment humidity in the environment of the housing 420, e.g., as described below.

In other aspects, controller 450 may be configured to control the activation of the light projector 412 based on any other additional or alternative criteria.

In some demonstrative aspects, controller 450 may be configured to activate the light projector 412, for example, based on a determination that the environment temperature is below a predefined temperature threshold, e.g., as described below.

In some demonstrative aspects, the predefined temperature threshold may be no more than 5 degrees Celsius, e.g., as described below.

In some demonstrative aspects, any other temperature threshold may be used.

In some demonstrative aspects, controller 450 may be configured to activate the light projector 412, for example, based on a determination that the environment temperature is below a dew point, e.g., as described below.

In some demonstrative aspects, controller 450 may be configured to activate the light projector 412, for example, based on a determination that the environment temperature is below a freezing point, e.g., as described below.

In some demonstrative aspects, controller 450 may be configured to control an intensity of the light of the second configuration projected by the light projector 412, for example, based on the environment temperature, e.g., as described below.

In some demonstrative aspects, controller 450 may be configured to control an intensity of the light of the second configuration projected by the light projector 412, for example, based on the environment humidity, e.g., as described below.

In some demonstrative aspects, controller 450 may be configured to cause the light projector 412 to project the light of the second configuration at a first intensity, for example, based on a determination that environment temperature is below a first temperature point, e.g., as described below.

In some demonstrative aspects, controller 450 may be configured to cause the light projector 412 to project the light of the second configuration at a second intensity, for example, based on a determination that the environment temperature is below a second temperature point, e.g., as described below.

In some demonstrative aspects, the second intensity may be higher than the first intensity, e.g., as described below.

In some demonstrative aspects, the second temperature point may be lower than the first temperature point, e.g., as described below.

In some demonstrative aspects, controller 450 may be configured to control operation of light projector 412 at one or more mode of operation, e.g., as described below.

In some demonstrative aspects, controller 450 may implement a current driver, e.g., a low noise ASIC current diver, to drive the optical source of light projector 412, for example, according to a predefined duty cycle.

In some demonstrative aspects, one or more functionalities and/or operations of controller may be, for example, included in, and/or managed by, a controller or processor of the light-based sensor 410, e.g., by processor 104 (FIG. 1).

In one example, a specialized duty cycle regime may be implemented by controller 450, for example, to operate light projector 412. For example, the specialized duty cycle regime may be defined by a pre-configured driver system scheme, e.g., including a low noise ASIC current driver to optical source, which may be managed, for example, by a LiDAR processor of the light-based sensor 410.

In some demonstrative aspects, controller 450 may be configured to control operation of light projector 412 according to an ice-melting mode of operation, e.g., as described below.

In some demonstrative aspects, controller 450 may be configured to control operation of light projector 412 according to condensed water evaporation mode of operation, e.g., as described below.

In one example, a first duty cycle scheme, e.g., using a high current and/or longer duty cycles, may be defined, for example, for the ice melting mode.

In another example, a second duty cycle scheme, for example, a low duty cycle using high output power bursts, may be defined, for example, to maintain window 430 at temperatures above freezing water temperature, and/or to evaporate condensed water.

In some demonstrative aspects, controller may be configured to cause, control and/or trigger activation (“start”) and/or deactivation (“stop”) of light projector 412, for example, based on an environment temperature of the environment of light-based sensor device 400, and/or based on an environment humidity of the environment of light-based sensor device 400.

In one example, the temperature of the window 430 and/or the environment of light-based sensor device 400 may be monitored, for example, based on information from one or more sensors, which may be located, for example, near the window 430.

In another example, the temperature of the window 430 and/or the environment of light-based sensor device 400 may be monitored, for example, based on the sensor information provided by light-based sensor 410. For example, the temperature of the window 430 and/or the environment of light-based sensor device 400 may be monitored, for example, based on a close loop analysis of a cloud map for range detections, which may be generated based on the sensor information provided by light-based sensor 410. According to this example, an inner calibration may be used.

In some demonstrative aspects, light-based sensor device 400 may be configured to provide a user with a suitable user interface, for example, to provide the user with manual control of the activation and/or the deactivation of light projector 412.

In some demonstrative aspects, controller 450 may be configured to control, cause, and/or trigger operation of light projector 612 according to one or more operation modes corresponding to a state of a vehicle implementing the light-based sensor device 400, e.g., as descried below.

In some demonstrative aspects, controller 450 may be configured to control, cause, and/or trigger operation of light projector 412 to operate according to a first mode, e.g., an in-situ mode, for example, while the vehicle is at a driving state.

For example, controller 450 may be configured to control, cause, and/or trigger operation of light projector 412 to heat the window 430 according to a first predefined heating scheme, for example, based on a determination that the temperature drops below a dew point or a freezing point, e.g., depending on a climate condition. For example, the first predefined heating scheme may be configured to heat window 430, for example, by a temperature of between 5-10° C., for example, within a time period, e.g., of less than 30 seconds.

In some demonstrative aspects, controller 450 may be configured to control, cause, and/or trigger operation of light projector 412 to operate according to a second mode, e.g., a cold-start mode, for example, while the vehicle is parked.

For example, controller 450 may be configured to control, cause, and/or trigger operation of light projector 412 to heat the window 430 according to a second predefined heating scheme, for example, based on a determination that the temperature drops below a dew point or a freezing point, e.g., depending on a climate condition. For example, the second predefined heating scheme may be configured to heat window 430, for example, by a temperature of between 20-40° C., for example, within a time period, e.g., of about 5-8 minutes. In one example, the light projector 412 may be operated to heat the window 430 according to the second predefined heating scheme, for example, after ice is removed from the window 430.

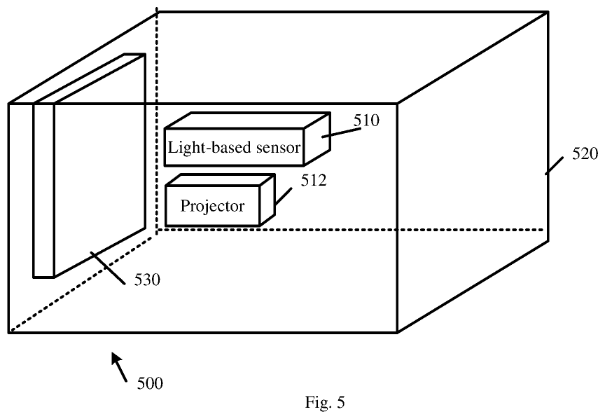

Reference is made to FIG. 5, which schematically illustrates an isometric view of a light-based sensor device 500, in accordance with some demonstrative aspects. For example, light-based sensor device 400 (FIG. 4) may include one or more elements of light-based sensor device 500, and/or may perform one or more operations and/or functionalities of light-based sensor device 500.

In some demonstrative aspects, as shown in FIG. 5, light-based sensor device 500 may include a light-based sensor 510 configured to sense light of a first configuration. For example, light-based sensor 410 (FIG. 4) may include one or more elements of light-based sensor 510, and/or may perform one or more operations and/or functionalities of light-based sensor device 510.

In some demonstrative aspects, as shown in FIG. 5, light-based sensor device 500 may include a housing 520 configured to house the light-based sensor 510. For example, housing 420 (FIG. 4) may include one or more elements of housing 520.

In some demonstrative aspects, housing 520 may include a window 530, for example, to enable light of the first configuration to pass between light-based sensor 510 and an environment of device 500, e.g., external to the housing 520. For example, window 430 (FIG. 4) may include one or more elements of window 530, and/or may perform one or more operations and/or functionalities of window 530.

In some demonstrative aspects, as shown in FIG. 5, light-based sensor device 500 may include a light projector 512. For example, light projector 412 (FIG. 4) may include one or more elements of light projector 512, and/or may perform one or more operations and/or functionalities of light-based sensor device light projector 512, e.g., as described below.

In some demonstrative aspects, light projector 512 may be configured to project light of a second configuration onto the window 530, e.g., as described below.

In some demonstrative aspects, light-based sensor 510 may be configured to generate sensor information, for example, based on light of the first configuration received via the window 530.

In some demonstrative aspects, light projector 512 may be configured to project light of the second configuration onto the window 530, for example, to heat the window 530, for example, by absorption of the light of the second configuration by window 530, e.g., by absorption of at least 30% of the light of the second configuration by window 530.

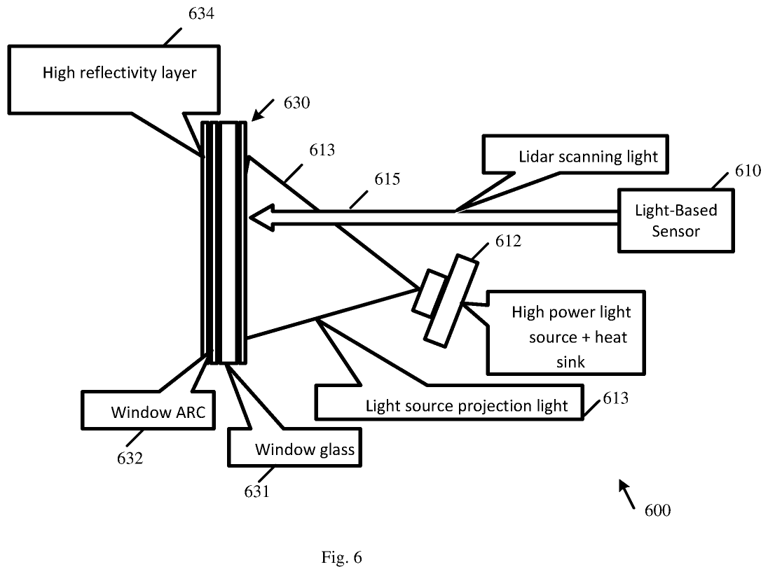

Reference is made to FIG. 6, which schematically illustrates a heating scheme 600 to heat a window 630 for a light-based sensor device including a light-based sensor 610, in accordance with some demonstrative aspects. For example, window 430 (FIG. 4) may include one or more elements of window 630, and/or may perform one or more operations and/or functionalities of window 630. For example, light-based sensor 410 (FIG. 4) may include one or more elements of light-based sensor 610, and/or may perform one or more operations and/or functionalities of light-based sensor 610.

In some demonstrative aspects, as shown in FIG. 6, the light-based sensor 610 may be configured to generate sensor information based on light 615 of a first configuration, which may be transmitted and received via the window 630. For example, as shown in FIG. 6, the light-based sensor 610 may include a LiDAR device.

In some demonstrative aspects, as shown in FIG. 6, heating scheme 600 may include a light projector 612 configured to project light 613 onto the window 630. For example, light projector 412 (FIG. 4) may include one or more elements of light projector 612, and/or may perform one or more operations and/or functionalities of light-based sensor device light projector 612, e.g., as described below.

In some demonstrative aspects, as shown in FIG. 6, light projector 612 may be configured to project onto window 630 light 613 of a second configuration, which may be configured to heat the window 630 by absorption, e.g., as described below. For example, the light 613 of the second configuration may be configured such that the window 630 is to be heated by absorption of the light 613 of the second configuration, e.g., as described below.

In some demonstrative aspects, light projector 612 may be configured to project light 613 of the second configuration onto the window 630, for example, to heat the window 630, for example, by absorption of at least 30% of the light 613 of the second configuration by window 630.

In some demonstrative aspects, light projector 612 may include a high power light source having an output power, e.g., equal to or greater than 10 Watts, e.g., as described below.

In some demonstrative aspects, light projector 612 may include a light source, which may be implemented, for example, by a LED, or a diffused laser output, and/or a VSCEL array. For example, light projector 612 may include one or more diffractive optical elements, which may be in a housing of the light-based sensor device, e.g., a LiDAR inner enclosure, for example, to project light 613 onto the window 630.

In some demonstrative aspects, light projector 612 may be configured to generate the light 613 having a spectrum and/or polarization state, which may be configured to be absorbed by a glass substrate layer 631 of window 630. In one example, glass substrate layer 631 may include a coated glass substrate of window 630.

In some demonstrative aspects, light projector 612 may be configured to generate the light 613 including Transverse-Magnetic (TM) polarized light, which may be absorbed by glass substrate layer 631.

For example, light projector 612 may be configured to generate the light 613 including TM polarized light of a wavelength, for example, a wavelength in the range between about 600 nm and about 700 nm, which may pass through one or more layers of window 630, e.g., an ARC layer 632, and which may be absorbed by the glass substrate layer 631.

In some demonstrative aspects, the glass substrate layer 631 may include a long pass glass layer, and light projector 612 may be configured to generate the light 613 including TM polarized light of a wavelength, for example, in the range between about 600 nm and about 700 nm.

For example, light projector 612 may be configured to generate the light 613 including TM polarized light of a wavelength, for example, in the range between about 650 nm and about 680 nm.

In one example, light projector 612 may be configured to generate the light 613 including TM polarized light of a wavelength of about 660 nm.

In some demonstrative aspects, as shown in FIG. 6, heating scheme 600 may include a reflective layer 634, which may be configured reflect back onto the glass substrate layer 631 at least some of the light 613, which has not been absorbed by the glass substrate layer 631.

For example, reflective layer 634 may include a high-reflectance layer, which may be on an outer side of window 630. For example, reflective layer 634 may be deposited on the outer side of window 630, e.g., over glass substrate layer 631. For example, reflective layer 634 may be configured to reflect back onto the glass substrate layer 631 projected light 613 that has not been absorbed by the ARC layer 632 and/or the glass substrate layer 631 of window 630.

In some demonstrative aspects, reflective layer 634 may be configured to mitigate and/or eliminate emission of the projected light 613, e.g., outside a system of the light-based sensor device.

In some demonstrative aspects, light projector 612 may be configured to generate the light 613, for example, such that the light 613 may have substantially no impact on performance of the light-based sensor 610, e.g., on a LiDAR performance of the light-based sensor 610. For example, the light-based sensor 610 may include a LiDAR sensor, which may utilize a Frequency-Modulated Continuous Wave (FMCW). The LiDAR FMCW may have a relatively high degree of sensitivity, e.g., to wavelength, direction, and/or polarization of return signals.

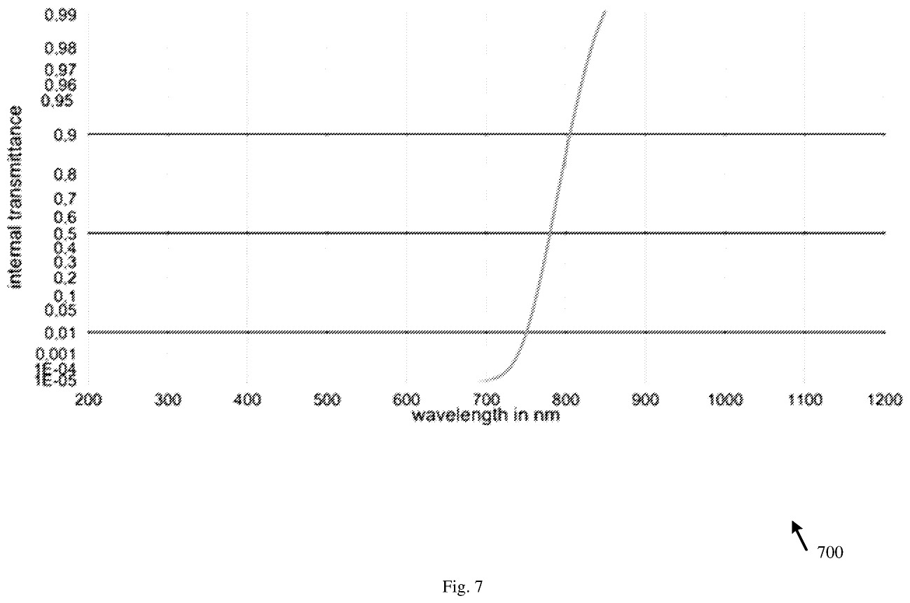

Reference is made to FIG. 7, which schematically illustrates a graph 700 depicting transmission of a glass substrate versus wavelength, in accordance with some demonstrative aspects. For example, the graph 700 may correspond to a long-pass glass substrate.

In some demonstrative aspects, as shown in FIG. 7, the glass substrate may transmit more than 90% of light of wavelengths above about 880 nm.

In some demonstrative aspects, as shown in FIG. 7, the glass substrate may absorb substantially all light of wavelengths below about 700 nm.

In some demonstrative aspects, glass substrate layer 631 (FIG. 6) may be formed of a glass substrate having transmission characteristics according to graph 700.

In some demonstrative aspects, light-based sensor 610 (FIG. 6) may be configured to transmit and/or receive light 615 (FIG. 6) of a wavelength above about 800 nm. For example, light-based sensor 610 (FIG. 6) may include a LiDAR sensor configured to transmit and/or receive light 615 (FIG. 6) of wavelengths above about 1000 nm. According to these aspects, the light 615 (FIG. 6) utilized by light-based sensor 610 (FIG. 6) may pass through window 630 (FIG. 6), e.g., without substantially any loss.

In some demonstrative aspects, light projector 612 (FIG. 6) may be configured to project onto window 630 (FIG. 6) light 613 (FIG. 6) of a wavelength less than about 800 nm. For example, light projector 612 (FIG. 6) may be configured to project onto window 630 (FIG. 6) light 613 (FIG. 6) of a wavelength of less than about 700 nm. According to these aspects, the light 613 (FIG. 6) utilized by light projector 612 (FIG. 6) may be absorbed by window 630 (FIG. 6), e.g., to heat the window 630 (FIG. 6).

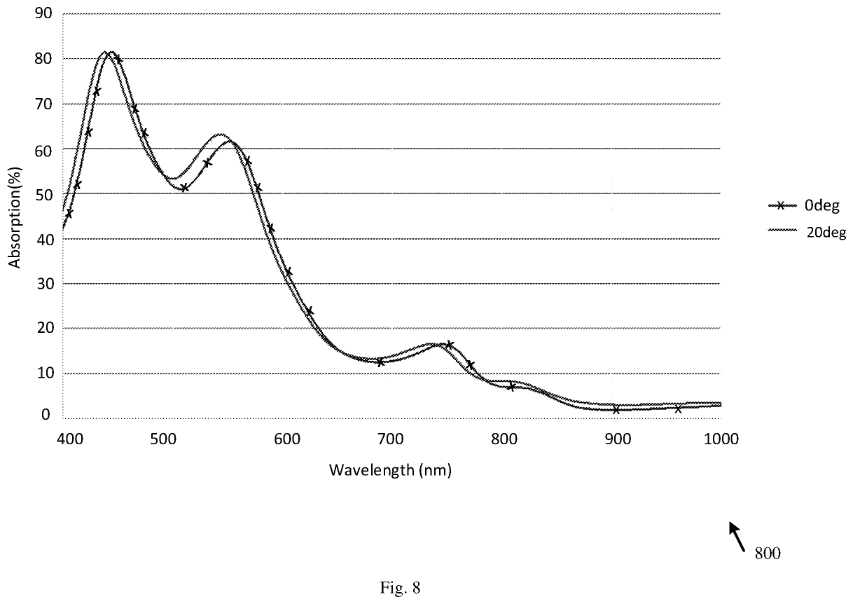

Reference is made to FIG. 8, which schematically illustrates a graph 800 depicting absorption of an ARC layer versus wavelength, in accordance with some demonstrative aspects.

In some demonstrative aspects, as shown in FIG. 8, the ARC layer may transmit more than 90% of light of wavelengths above about 800 nm.

In some demonstrative aspects, as shown in FIG. 8, the ARC layer may absorb about 50-80% of light of wavelengths between about 400 nm and about 550 nm.

In some demonstrative aspects, as shown in FIG. 8, the ARC layer may absorb about 70-80% of light of wavelengths between about 420 nm and about 480 nm.

In some demonstrative aspects, ARC layer 632 (FIG. 6) may be formed of an ARC layer having absorption characteristics according to graph 800.

In some demonstrative aspects, light-based sensor 610 (FIG. 6) may be configured to transmit and/or receive light 615 (FIG. 6) of a wavelength above about 800 nm. For example, light-based sensor 610 (FIG. 6) may include a LiDAR sensor configured to transmit and/or receive light 615 (FIG. 6) of wavelengths above about 1000 nm. According to these aspects, the light 615 (FIG. 6) utilized by light-based sensor 610 (FIG. 6) may pass through ARC layer 632 (FIG. 6), e.g., without substantially any loss.

In some demonstrative aspects, light projector 612 (FIG. 6) may be configured to project onto window 630 (FIG. 6) light 613 (FIG. 6) of a wavelength in the range between about 400 nm-600 nm. For example, light projector 612 may be configured to project onto window 630 (FIG. 6) light 613 (FIG. 6) of a wavelength in the range of about 420 nm-480 nm. According to these aspects, the light 613 (FIG. 6) utilized by light projector 612 (FIG. 6) may be absorbed by the ARC layer 632 (FIG. 6) of window 630 (FIG. 6), e.g., to heat the window 630 (FIG. 6).

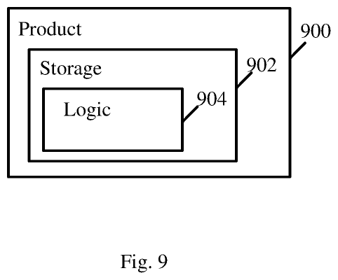

Reference is made to FIG. 9, which schematically illustrates a product of manufacture 900, in accordance with some exemplary aspects. Product 900 may include one or more tangible computer-readable (“machine-readable”) non-transitory storage media 902, which may include computer-executable instructions, e.g., implemented by logic 904, operable to, when executed by at least one computer processor, enable the at least one computer processor to implement one or more operations at a light-based sensor device, e.g., light-based sensor device 101 (FIG. 1), light-based sensor device 300 (FIG. 3), light-based sensor device 400 (FIG. 4), and/or light-based sensor device 500 (FIG. 5), and/or controller, e.g., controller 450 (FIG. 4); to cause a light-based sensor device, e.g., light-based sensor device 101 (FIG. 1), light-based sensor device 300 (FIG. 3), light-based sensor device 400 (FIG. 4), and/or light-based sensor device 500 (FIG. 5), and/or controller, e.g., controller 450 (FIG. 4), to perform, trigger and/or implement one or more operations and/or functionalities; and/or to perform, trigger and/or implement one or more operations and/or functionalities described with reference to the FIGS. 1-8, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 900 and/or machine-readable storage media 902 may include one or more types of computer-readable storage media capable of storing data, including volatile memory, non-volatile memory, removable or non-removable memory, erasable or non-erasable memory, writeable or re-writeable memory, and the like. For example, machine-readable storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a Solid State Drive (SSD), a disk, a drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 904 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language.

### Examples

The following examples pertain to further aspects.

Example 1 includes an apparatus comprising a housing comprising a window; a sensor, e.g., a light-based sensor, to generate sensor information based on light of a first configuration received via the window; and a light projector configured to project light of a second configuration onto the window, wherein the light of the second configuration is configured to heat the window by absorption, e.g., such that the window is to be heated by absorption of the light of the second configuration.

Example 2 includes the subject matter of Example 1, and optionally, comprising a controller configured to control activation of the light projector based on at least one of an environment temperature in an environment of the housing, or an environment humidity in the environment of the housing.

Example 3 includes the subject matter of Example 2, and optionally, wherein the controller is configured to control an intensity of the light of the second configuration based on at least one of the environment temperature, or the environment humidity.

Example 4 includes the subject matter of Example 3, and optionally, wherein the controller is configured to cause the light projector to project the light of the second configuration at a first intensity based on a determination that the environment temperature is below a first temperature point, and to cause the light projector to project the light of the second configuration at a second intensity based on a determination that the environment temperature is below a second temperature point, wherein the second intensity is higher than the first intensity and the second temperature point is lower than the first temperature point.

Example 5 includes the subject matter of any one of Examples 2-4, and optionally, wherein the controller is configured to activate the light projector based on a determination that the environment temperature is below a predefined temperature threshold.

Example 6 includes the subject matter of Example 5, and optionally, wherein the predefined temperature threshold is no more than 5 degrees Celsius.

Example 7 includes the subject matter of any one of Examples 2-6, and optionally, wherein the controller is configured to activate the light projector based on a determination that the environment temperature is below at least one of a dew point or a freezing point.

Example 8 includes the subject matter of any one of Examples 1-7, and optionally, wherein the window comprises a window layer and a reflective layer on the window layer, wherein the window layer is between, e.g., disposed between, the light projector and the reflective layer, wherein the reflective layer is configured to reflect the light of the second configuration back onto the window layer.

Example 9 includes the subject matter of any one of Examples 1-8, and optionally, wherein the window comprises a window layer and an absorption layer, e.g., on the window layer, wherein the light of the second configuration is configured to heat the window by absorption of at least 30% of the light of the second configuration by at least one of the window layer or the absorption layer.

Example 10 includes the subject matter of any one of Examples 1-9, and optionally, wherein the window comprises a window layer and an Anti-Reflective Coating (ARC) layer on the window layer, wherein the light of the second configuration is configured to heat the window by absorption of at least 30% of the light of the second configuration by at least one of the window layer or the ARC layer.

Example 11 includes the subject matter of any one of Examples 1-10, and optionally, wherein the light of the second configuration comprises light of a wavelength which is at least 30% absorbed by the window.

Example 12 includes the subject matter of any one of Examples 1-11, and optionally, wherein the light of the second configuration comprises light of a polarity which is at least 30% absorbed by the window.

Example 13 includes the subject matter of any one of Examples 1-12, and optionally, wherein the light of the second configuration comprises light having a wavelength, which is in a wavelength range between about 600 nanometer (nm) and about 700 nm.

Example 14 includes the subject matter of any one of Examples 1-12, and optionally, wherein the light of the second configuration comprises light having a wavelength, which is in a wavelength range between about 650 nanometer (nm) and about 680 nm.

Example 15 includes the subject matter of any one of Examples 1-12, and optionally, wherein the light of the second configuration comprises Ultra Violet (UV) light.

Example 16 includes the subject matter of Example 15, and optionally, wherein the light of the second configuration comprises light having a wavelength, which is in a wavelength range between about 250 nanometer (nm) and about 300 nm.

Example 17 includes the subject matter of any one of Examples 1-12, and optionally, wherein the light of the second configuration comprises Mid-wave Infra-Red (MWIR) light.

Example 18 includes the subject matter of Example 17, and optionally, wherein the light of the second configuration comprises light having a wavelength, which is greater than about 2400 nm.

Example 19 includes the subject matter of any one of Examples 13-18, and optionally, wherein the window comprises a glass substrate configured to absorb at least 30% of the light of the second configuration.

Example 20 includes the subject matter of any one of Examples 1-12, and optionally, wherein the light of the second configuration comprises light having a wavelength, which is in a wavelength range between about 400 nanometer (nm) and about 600 nm.

Example 21 includes the subject matter of any one of Examples 1-12, and optionally, wherein the light of the second configuration comprises light having a wavelength, which is in a wavelength range between about 420 nanometer (nm) and about 480 nm.

Example 22 includes the subject matter of Example 20 or 21, and optionally, wherein the window comprises a window layer and an Anti-Reflective Coating (ARC) layer on the window layer, the ARC layer configured to absorb at least 30% of light in the wavelength range between about 400 nm and about 600 nm.

Example 23 includes the subject matter of any one of Examples 1-22, and optionally, wherein the sensor, e.g., the light-based sensor, comprises a light transmitter to transmit the light of the first configuration via the window, and a light detector to detect the light of the first configuration received via the window.

Example 24 includes the subject matter of Example 23, and optionally, wherein the sensor, e.g., the light-based sensor, comprises a Light Detection and Ranging (LiDAR) sensor.

Example 25 includes the subject matter of any one of Examples 1-24, and optionally, wherein the light of the first configuration comprises light having a wavelength, which is in a wavelength range between about 800 nanometer (nm) and about 1500 nm.

Example 26 includes the subject matter of any one of Examples 1-25, and optionally, wherein the window is configured to transmit at least 80% of the light of the first configuration.

Example 27 includes the subject matter of any one of Examples 1-26, and optionally, wherein the window is configured to transmit at least 90% of the light of the first configuration.

Example 28 includes the subject matter of any one of Examples 1-27, and optionally, wherein the light of the second configuration is configured to heat the window by absorption of at least 30% of the light of the second configuration by the window.

Example 29 includes the subject matter of any one of Examples 1-28, and optionally, wherein the light of the second configuration is configured to heat the window by absorption of at least 40% of the light of the second configuration by the window.

Example 30 includes the subject matter of any one of Examples 1-29, and optionally, wherein the light of the second configuration is configured to heat the window by absorption of at least 50% of the light of the second configuration by the window.

Example 31 includes the subject matter of any one of Examples 1-30, and optionally, wherein the light of the second configuration is configured to heat the window by absorption of at least 60% of the light of the second configuration by the window.

Example 32 includes the subject matter of any one of Examples 1-31, and optionally, wherein the light of the second configuration is configured to heat the window by absorption of at least 70% of the light of the second configuration by the window.

Example 33 includes the subject matter of any one of Examples 1-32, and optionally, wherein the light of the second configuration is configured to heat the window by absorption of at least 80% of the light of the second configuration by the window.

Example 34 includes the subject matter of any one of Examples 1-33, and optionally, wherein the light of the second configuration is configured to heat the window at a rate of at least 1 degree Celsius per minute.

Example 35 includes the subject matter of any one of Examples 1-34, and optionally, wherein the light of the second configuration is configured to heat the window at a rate of at least 2 degrees Celsius per minute.

Example 36 includes the subject matter of any one of Examples 1-35, and optionally, wherein the light of the second configuration is configured to heat the window at a rate of at least 5 degrees Celsius per minute.

Example 37 includes the subject matter of any one of Examples 1-36, and optionally, wherein the light of the second configuration is configured to heat the window at a rate of at least 10 degrees Celsius per minute.

Example 38 includes the subject matter of any one of Examples 1-37, and optionally, wherein the light projector comprises at least one of a Light Emitting Diode (LED), a diffused laser, or a Vertical Cavity Surface Emitting Lasers (VCSEL) array to generate the light of the second configuration.

Example 39 includes the subject matter of any one of Examples 1-38, and optionally, comprising a vehicle, the vehicle comprising a system controller to control one or more systems of the vehicle based on the sensor information.

Example 40 includes a Light Detection and Ranging (LiDAR) device comprising the apparatus of any of Examples 1-38.

Example 41 includes a vehicle comprising the apparatus of any of Examples 1-38.

Example 42 includes an apparatus comprising means for executing any of the described operations of any of Examples 1-38.

Example 43 includes a machine-readable medium that stores instructions for execution by a processor to perform any of the described operations of any of Examples 1-38.

Example 44 comprises a product comprising one or more tangible computer-readable non-transitory storage media comprising computer-executable instructions operable to, when executed by at least one processor, enable the at least one processor to cause a computing device to perform any of the described operations of any of Examples 1-38.

Example 45 includes an apparatus comprising a memory; and processing circuitry configured to perform any of the described operations of any of Examples 1-38.

Example 46 includes a method including any of the described operations of any of Examples 1-38.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a housing comprising a window;
a sensor to generate sensor information based on light of a first configuration received via the window; and
a light projector configured to project light of a second configuration onto the window, wherein the light of the second configuration is configured such that the window is to be heated by absorption of the light of the second configuration.

2. The apparatus of claim 1 comprising a controller configured to control activation of the light projector based on at least one of an environment temperature in an environment of the housing, or an environment humidity in the environment of the housing.

3. The apparatus of claim 2, wherein the controller is configured to control an intensity of the light of the second configuration based on at least one of the environment temperature, or the environment humidity.

4. The apparatus of claim 3, wherein the controller is configured to cause the light projector to project the light of the second configuration at a first intensity based on a determination that the environment temperature is below a first temperature point, and to cause the light projector to project the light of the second configuration at a second intensity based on a determination that the environment temperature is below a second temperature point, wherein the second intensity is higher than the first intensity and the second temperature point is lower than the first temperature point.

5. The apparatus of claim 2, wherein the controller is configured to activate the light projector based on a determination that the environment temperature is below at least one of a dew point or a freezing point.

6. The apparatus of claim 1, wherein the window comprises a window layer and a reflective layer on the window layer, wherein the window layer is disposed between the light projector and the reflective layer, wherein the reflective layer is configured to reflect the light of the second configuration back onto the window layer.

7. The apparatus of claim 1, wherein the window comprises a window layer and an absorption layer, wherein the light of the second configuration is configured to heat the window by absorption of at least 30% of the light of the second configuration by at least one of the window layer or the absorption layer.

8. The apparatus of claim 1, wherein the window comprises a window layer and an Anti-Reflective Coating (ARC) layer on the window layer, wherein the light of the second configuration is configured to heat the window by absorption of at least 30% of the light of the second configuration by at least one of the window layer or the ARC layer.

9. The apparatus of claim 1, wherein the light of the second configuration comprises light of a wavelength which is at least 30% absorbed by the window.

10. The apparatus of claim 1, wherein the light of the second configuration comprises light of a polarity which is at least 30% absorbed by the window.

11. The apparatus of claim 1, wherein the light of the second configuration comprises light having a wavelength, which is in a wavelength range between about 600 nanometer (nm) and about 700 nm.

12. The apparatus of claim 1, wherein the light of the second configuration comprises Ultra Violet (UV) light.

13. The apparatus of claim 1, wherein the light of the second configuration comprises light having a wavelength, which is in a wavelength range between about 250 nanometer (nm) and about 300 nm.

14. The apparatus of claim 1, wherein the light of the second configuration comprises Mid-wave Infra-Red (MWIR) light.

15. The apparatus of claim 1, wherein the light of the second configuration comprises light having a wavelength, which is in a wavelength range between about 400 nanometer (nm) and about 600 nm.

16. The apparatus of claim 1, wherein the sensor comprises a light transmitter to transmit the light of the first configuration via the window, and a light detector to detect the light of the first configuration received via the window.

17. The apparatus of claim 16, wherein the sensor comprises a Light Detection and Ranging (LiDAR) sensor.

18. The apparatus of claim 1, wherein the light of the first configuration comprises light having a wavelength, which is in a wavelength range between about 800 nanometer (nm) and about 1500 nm.

19. The apparatus of claim 1, wherein the window is configured to transmit at least 80% of the light of the first configuration.

20. The apparatus of claim 1, wherein the light of the second configuration is configured to heat the window by absorption of at least 30% of the light of the second configuration by the window.

21. The apparatus of claim 1, wherein the light of the second configuration is configured to heat the window at a rate of at least 1 degree Celsius per minute.

22. A Light Detection and Ranging (LiDAR) device comprising:
a housing comprising a window;
a LiDAR sensor within the housing, the LiDAR sensor comprising a light transmitter to transmit light of a first configuration via the window, and a light detector to detect received light of the first configuration via the window, wherein the LiDAR sensor is configured to generate LiDAR sensor information based on the received light of the first configuration; and
a light projector within the housing, the light projector configured to project light of a second configuration onto the window, wherein the light of the second configuration is configured such that the window is to be heated by absorption of the light of the second configuration.

23. The LiDAR device of claim 22 comprising a controller configured to control activation of the light projector based on at least one of an environment temperature in an environment of the housing, or an environment humidity in the environment of the housing.

24. A vehicle comprising:
a system controller configured to control one or more vehicular systems of the vehicle based on Light Detection and Ranging (LiDAR) information; and
a LiDAR device configured to generate the LiDAR information, the LiDAR device comprising:
a housing comprising a window;
a LiDAR sensor within the housing, the LiDAR sensor comprising a light transmitter to transmit light of a first configuration via the window, and a light detector to detect received light of the first configuration via the window, wherein the LiDAR sensor is configured to generate LiDAR sensor information based on the received light of the first configuration;
a light projector within the housing, the light projector configured to project light of a second configuration onto the window, wherein the light of the second configuration is configured such that the window is to be heated by absorption of the light of the second configuration; and
a processor to generate the LiDAR information based on the LiDAR sensor information.

25. The vehicle of claim 24 comprising a controller configured to control activation of the light projector based on at least one of an environment temperature in an environment of the vehicle, or an environment humidity in the environment of the vehicle.
